(19) United States
(12) Patent Application Publication
(10) Pub. No.: US 2006/0151674 A1
(43) Pub. Date: Jul. 13, 2006

(54) Cushioned article holder with deformable arms

(75) Inventor: Dennis H. Hancock, Mountain Green, UT (US)

Correspondence Address: Timothy B. Smith, Suite 1300, 185 South State Street, Salt Lake City, UT, 84111, US

(73) Assignee: Stearns, Inc.

(21) Appl. No.: 11/032,735

(22) Filed: Jan. 10, 2005

(51) Int. Cl. F16L 3/08

(52) U.S. Cl. 248/74.3

(57) ABSTRACT

An article holder having bifurcated arms extending from a common base and bendable cores within the arms that allow the arms to be bent to desired position and having resilient cushion means that will stretch and relax as necessary to provide adequate cushion means for articles placed between the arms. A stretchable cover material encases the bifurcated arms and common base and stretches and relaxes during bending of the arms.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO MICROFICHE APPENDIX

Not Applicable.

### BACKGROUND OF THE INVENTION

1. Field of the Invention

The present invention relates to holding devices that are easily mounted to racks of all terrain vehicles, snowmobiles and other vehicles, such as pick-up trucks. It is particularly concerned with article holders that allow an article to be inserted downwardly between bifurcated arms of a holder and that can be readily attached to such vehicles.

2. Prior Art

It has been well recognized that article holders having generally U-shaped receivers can be used to hold portions of a variety of elongate articles, including rifles, shotguns, bows and arrows, and even shovels and axes. Racks have been developed in the past that attach to a rear wall of a pick-up truck cab, to support such items. These racks commonly include a frame and spaced apart receptacles having U-shaped support holders for the articles.

More recently, article holders have been developed to utilize bifurcated arms projecting upwardly from a base and with means secured to the base that can be used to attach the article holder to a vehicle. Such article holders are disclosed, for example, in U.S. Pat. Nos. 5,078,239, 5,344,032, 5,915,572, 6,382,488 and 6,695,183 and, in addition, in published U.S. patent application Ser. No. 10/320,675.

The article holders disclosed in the aforementioned United States patents and application are particularly useful in retaining articles that need to be easily retrieved from such retaining structure. Rifles and shotguns, for example, often must be available for quick retrieval from an article holder to meet the needs of shooters and hunters. Thus, while it is often desirable to secure rifles and shotguns so that they are more securely retained, it is also desirable that article holders for such guns be capable of holding the guns so that a very quick retrieval is possible.

Since articles to be placed in the article holders of the type in the aforementioned patents described, may vary considerable in size and particularly in the widths to be inserted into the article holders, it is desirable that such article holders be constructed to accommodate portions of elongate articles of that are to be held and having varying widths.

Further, because the articles to be held by article holders of the type in the aforementioned patents described vary greatly in size, and particularly in the width of the article to be placed within the article holder, it is desirable that such article holder be able to accommodate the varying widths involved, while still adequately securing the article to be positioned. It has been found, for example, that the same article holder that may be suitable to receive the stock of a gun, does not work nearly so well in receiving portions of bows and arrows or receiving a portion of a fishing pole. It has also been found that article holders of the type in the aforementioned U.S. patents described, in general, cannot provide adequate cushioning support for articles of different widths inserted into and held by an article holder. The above identified U.S. patents, disclose article holders that recognize some of the features necessary to provide a suitable article holder. However, it does not appear that there has heretofore been developed an article holder that will provide for adjustment of bifurcated arms to accommodate articles of widely varying widths, placed between the arms. Further, it does not appear that the aforementioned U.S. patents recognize the need for providing an adjustable resilient cushion on which articles positioned within adjustable bifurcated arms are supported. Also, it does not appear that the aforementioned U.S. patents disclose a structure wherein a resilient cushion on which an article is to be supported, provides a degree of support that is determined by the width of the article to be supported and proper adjustment of bendable bifurcated arms.

### OBJECTS OF THE INVENTION

Principal objects of the present invention are to provide an article holder that will hold a portion of an elongate article, such that the article is protected from damage; that can secure an article for quick retrieval, when desired; that will secure an article against instant retrieval during periods of travel and/or other periods when the article is not to be retrieved on a quick basis; that will conform to and readily hold its shape to hold a portion of an article; and that will provide ample cushioning on which an article will rest, even as the bifurcated arms of the article are closed together, spread apart, or otherwise deformed.

Another object of the invention is to provide an article holder with bifurcated arms and holding structure between the arms that can be rotated to a best holding angle and then be secured in place.

Still another object is to provide an article holder for a portion of an elongate article that will not damage the article and that will hold such article for easy retrieval or that can be used for more positive holding of the article.

### FEATURES OF THE INVENTION

Principal features of the article holder of the invention includes deformable bendable bifurcated arms extending from a common base and having flexible fingers affixed to interior surfaces of the bifurcated arms.

Other features of the article holder of the present invention further include a cushion system positioned above the base of the article holder and between the bifurcated arms extending from the base. The cushion system is resilient and changes shape with bending of the bifurcated arms at the base. The cushion system is preferably formed integral with resilient cover material that encloses the bifurcated arms and base as a protection for articles positioned in the article holder.

Still other features of the invention include a threaded support bolt projecting from the base from which the bifurcated arms project to be fastened by a connector to a vehicle, or the like.

A lock nut is provided on the support bolt to secure the bifurcated arms of the article holder of the invention at a desired angle.

Additional objects and features of the invention will become apparent to persons skilled in the art to which the invention pertains from the following detailed description and claims.

### BRIEF DESCRIPTION OF THE FIGURES OF THE INVENTION

In the Drawings

FIG. 1 is a front elevation view of a article holder of the invention, shown secured to a mount, shown fragmentarily;

FIG. 2, a view like that of FIG. 1, but showing the bifurcated arms bent closer together;

FIG. 3, a view of an article holder of the invention with some coating material removed; and

FIG. 4, a front elevation view of the core material of the article holder of the invention, with all outer covering removed.

### DETAILED DESCRIPTION

Referring now the Drawings

In the illustrated preferred embodiment, the article holder of the invention is shown generally at 10.

Article holder 10 includes a pair of bifurcated arms 12 and 14 that each have one end fixed to a common base 16.

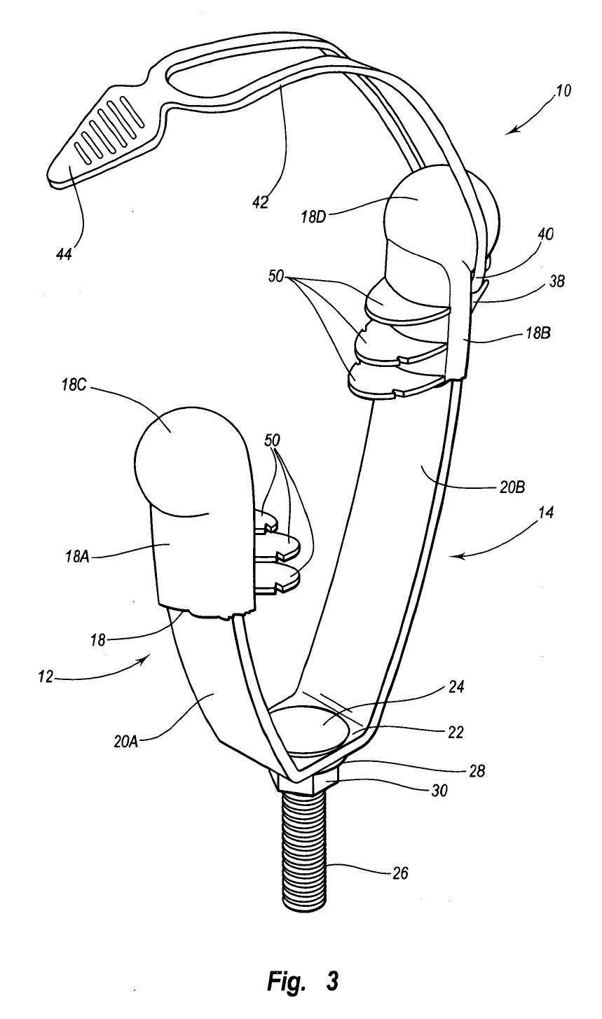

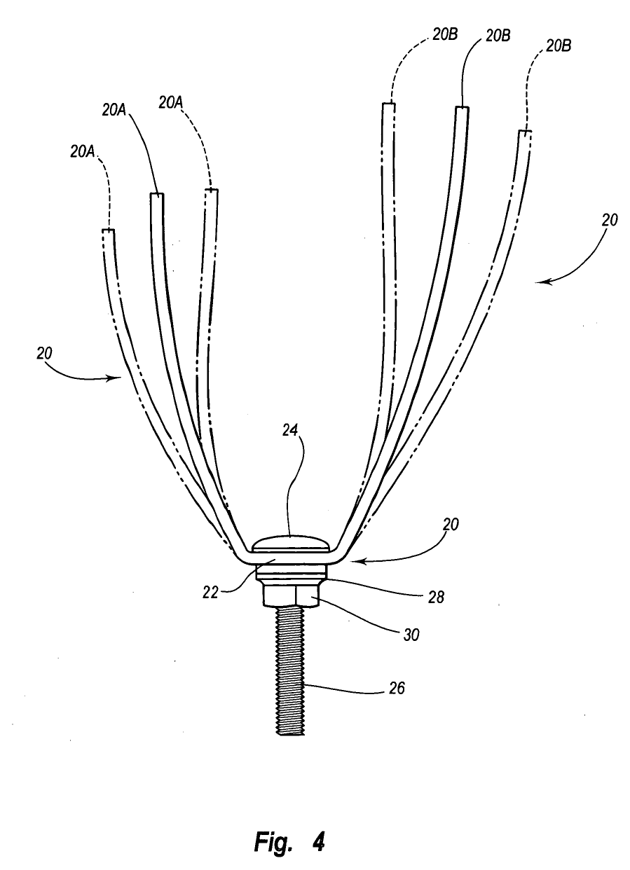

Each of the bifurcated arms 12 and 14 and the common base 16 is covered with a resilient rubberized or plasticzed coating material 18, shown best in FIG. 3. Bifurcated arm 12 has a core 20A and bifurcated arm 14 has a core 20B. The cores 20A and 20B of the arms 12 and 14 are interconnected by a common core 22 that forms a part of the common base 16. The material from which cores 20, 20B and core 22 are selected is a strong, durable, bendable material, such as steel, that will retain an assigned shape. Preferably the cores are formed as one piece from a single piece of core material 20. The material 20 from which cores 20A, 20B and 22 are formed is also sufficiently pliable that it can be forcefully bent by hand. The resilient rubberized or plasticzed resilient coating material 18 fit snugly, fully covering the cores 20A, 20B and 22 and the head 24 of a bolt 26 and head 24 that is inserted downwardly between the arms 12 and 14 and through the core 22.

Bolt 26 also passes through a washer 28 and is threaded through a nut 30. The coating material then also covers the washer 28 and nut 29.

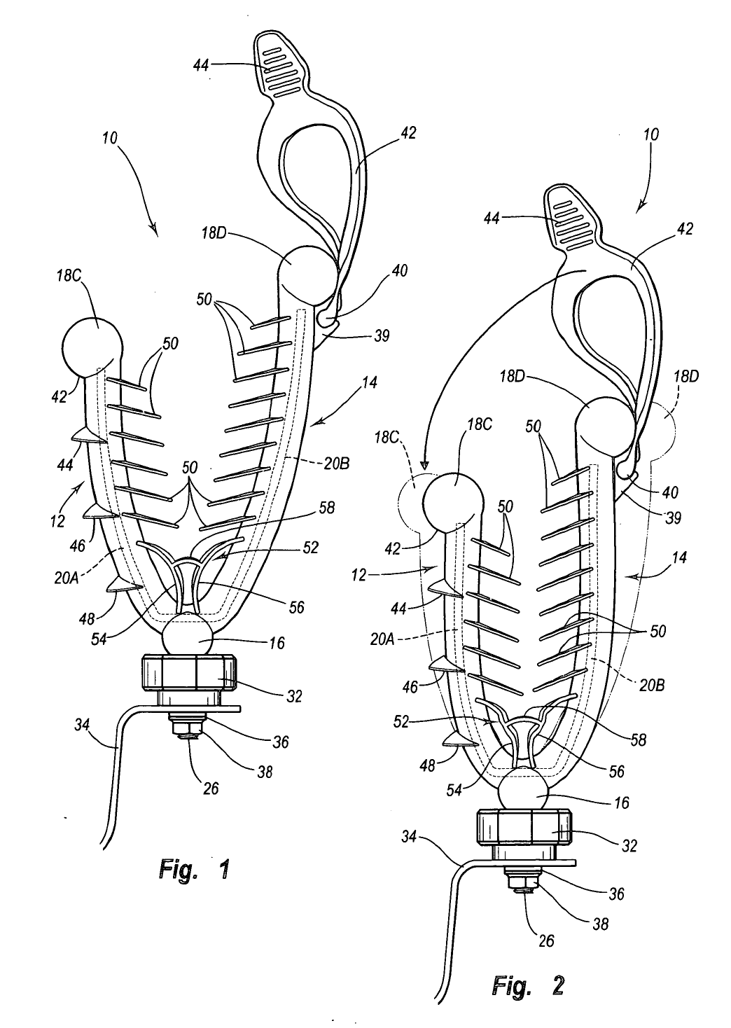

Another nut 32 is threaded onto bolt 26 and bolt 26 may be threaded into a bracket (not shown) to be attached to a vehicle or may be passed through a support bracket 34, shown fragmentarily in FIGS. 1 and 2. If passed through a support bracket 34, a washer 36 is preferably provided between the support bracket and a nut 38. Nut 32 is tightened down against support bracket 34 to secure the angular relationship of the article holder 10.

Portions 18A and 18B of coating material 18, respectively, cover arms 12 and 14. The coating material 18 also preferably forms resilient knobs 18C and 18D, respectively, on the face ends of arms 12 and 14. The resilient knobs protect articles being placed downwardly between the bifurcated arms from being scratched or otherwise damaged. A C-clip 39 is also formed by the coating material 18 beneath the knobs 18D. One end 40 of resilient band 42 is positioned in the C-clip and a tab 44 is provided on an opposite end of the resilient band 40. The pull tab is used to stretch the resilient band over knob 18C such that the band 42 is held on the arm 12 by the knob 18C. Alternatively, the band can be further stretched by pulling on tab 44 to catch beneath one of the spaced apart ears 44, 46 or 48 to positively hold an inserted article in position between the legs 12 and 14.

A plurality of downwardly and forwardly directed spaced apart, flexible fingers 50 are provided on each of the legs 12 and 14. The fingers 50 yield to allow insertion of a portion of an elongate article between the arms 12 and 14. Pressure of the resilient fingers on an inserted article and positioning of fingers past which an article has been inserted hold the article in place, while allowing quick, easy retrieval of the article from the article holder 10, whenever desired.

A resilient cushion 52 is provided between the legs 12 and 14 and above the common base 16. The resilient cushion includes a resilient member 54 curved inwardly from leg 12 and extending from a connection with the inside of the leg 12 to the common base 16. Similarly, a resilient member 56 curves inwardly from leg 14 and extends from a connection at the inside of leg 14 to the common base 16. Another upwardly curved strip 58 extends from the resilient member 54 to the resilient member 56.

Article holders of the type herein disclosed and capable of holding a portion of an elongate article using bifurcated arms, inwardly and downwardly extending fingers and cushion means between the bifurcated arms, as shown in the aforementioned U.S. patents. Also, it has been known to provide such article holders with a resilient band to more securely hold articles in the article holder. However, with the present invention, the deformable arms 12 and 14 are bendable to more closely fit against a portion of an article positioned in the article holder. The arms 12 and 14 can be bent to extend further away from one another and to receive an article having a greater width. The arms 12 and 14 can also be bent towards one another to receive a portion of an article having a smaller width.

The resilient cushion 52 provided above the common base 16 and connected to the arms 12 and 14 will remain in place as it is stretched or released to provide continuing support of an inserted article.

It will also be apparent that the arms 12 and 14 are each separately bendable, if desired, to better accommodate the shape of an article being secured by the article holder. The resilient coating material 18 will stretch and relax to maintain coverage over the arms 12 and 14 and common base 16, as one or both arms are bent to provide better accommodations of an article.

Although a preferred embodiment of my invention has been herein described, it is to be understood that the present disclosure is by way of example and that variations are possible without departing from the subject matter coming within the scope of the following claims, which subject matter I regard as my invention.

I claim:

1. An article holder comprising
a pair of bifurcated arms extending from a common base;
each said bifurcated arm having a core member extending substantially the length of the arm, said core member being made of a strong material that will bend by hand and that will retain a shape into which it is bent;
a resilient material covering said bifurcated arms and said common base; and
means projecting from said common base for connection to a mounting means on a vehicle.

2. An article holder as in claim 1, further comprising
resilient cushion means positioned between and secured to each of said bifurcated arms and above and secured to the common base.

3. An article holder as in claim 2, wherein the resilient cushion further comprises
a first resilient member curved upwardly from a connection with one bifurcated leg to engagement with the common base;
a second resilient member spaced from the first resilient member of the resilient cushion curved inwardly from a connection with the other leg into engagement with the common base; and
an upwardly curved resilient strip connected between said first and second resilient members.

4. An article holder as in claim 3, wherein
the resilient material covering the bifurcated arms and the base is integral with the resilient cushion.

5. An article holder as in claim 4, further comprising
a rounded knob formed from the resilient material covering the bifurcated arms and base; and
an elastic band connected to one of said arms and stretchable over the knob on the other of said arms.

6. An article holder as in claim 5, further comprising
spaced apart ears along the length of the other arm as attachment means for the elastic band.

7. An article holder as in claim 6, further comprising
lock means on the means projecting from the common case to selectively lock the angle of the bifurcated arms relative to mounting means on a vehicle.
